(19) United States
(12) Patent Application Publication
(10) Pub. No.: US 2025/0165347 A1
(43) Pub. Date: May 22, 2025

(54) MEMORY SUB-SYSTEM RECOVERY IN RESPONSE TO HOST HARDWARE RECOVERY SIGNAL

(71) Applicant: Micron Technology, Inc., Boise, ID (US)

(72) Inventors: Nicholas Terence Heath, Pittsboro, NC (US); Gaurav Sinha, Unterschleißheim (DE)

(21) Appl. No.: 18/927,473

(22) Filed: Oct. 25, 2024

Related U.S. Application Data
(60) Provisional application No. 63/601,171, filed on Nov. 20, 2023.

(51) Int. Cl. G06F 11/14; G06F 8/65

(52) U.S. Cl. CPC G06F 11/1417; G06F 8/65; G06F 11/1441

(57) ABSTRACT

A processing device in a memory sub-system performs a reboot sequence in response to an occurrence of a power cycle event and determines whether a recovery signal is asserted from a host system via a side-band interface. Responsive to determining that the recovery signal is asserted, the processing device retrieves and loads a backup firmware image for the memory sub-system and booting the memory sub-system in a debug operational mode.

### RELATED APPLICATIONS

This application claims the benefit of U.S. Provisional Patent Application No. 63/601,171, filed Nov. 20, 2023, the entire contents of which are hereby incorporated by reference herein.

### TECHNICAL FIELD

Embodiments of the disclosure relate generally to memory sub-systems, and more specifically, relate to recovery of a non-responsive memory sub-system using backup firmware enabled by a host-initiated hardware recovery signal.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram illustrating a computing system for recovery of a non-responsive memory sub-system using backup firmware enabled by a host-initiated hardware recovery signal in accordance with some embodiments of the present disclosure.

FIG. 3 is a sequence diagram illustrating recovery of a non-responsive memory sub-system using backup firmware enabled by a host-initiated hardware recovery signal in accordance with some embodiments of the present disclosure.

FIG. 4 is a flow diagram of an example method for recovery of a non-responsive memory sub-system using backup firmware enabled by a host-initiated hardware recovery signal in accordance with some embodiments of the present disclosure.

FIG. 5 is a block diagram of an example computer system in which embodiments of the present disclosure may operate.

### DETAILED DESCRIPTION

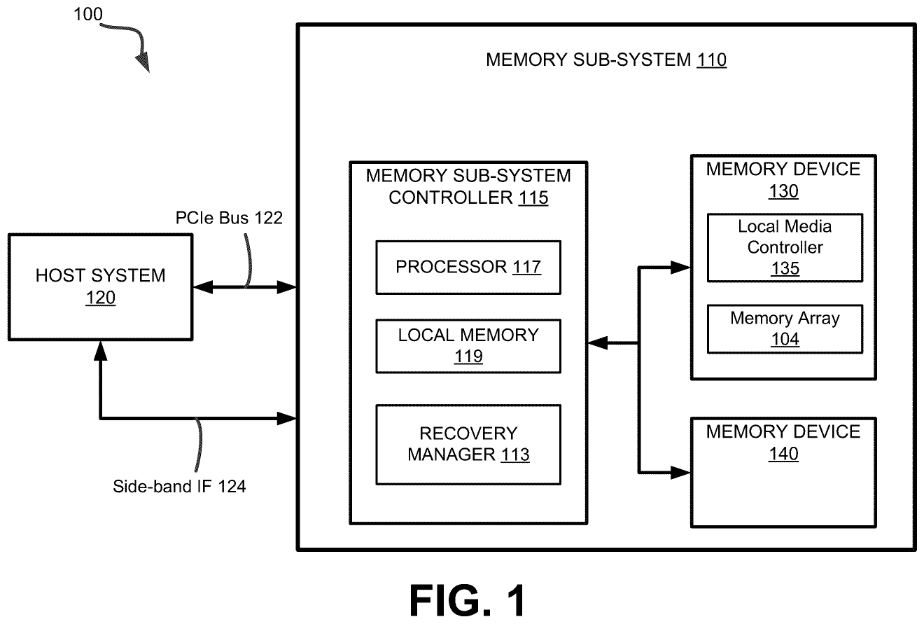

Aspects of the present disclosure are directed to recovery of a non-responsive memory sub-system using backup firmware enabled by a host-initiated hardware recovery signal. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

One example of a memory sub-system is a solid-state drive (SSD) that includes one or more non-volatile memory devices and a memory sub-system controller to manage the non-volatile memory devices. The memory devices can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

Like any electronic circuit, a memory sub-system is susceptible to various types of errors or faults that can impact performances and/or operability. For example faults in the firmware executing on the memory sub-system can cause the memory sub-system to become unresponsive, input/output errors can prevent communication with the host system, or a failure in the non-volatile memory devices of the memory sub-system can hinder the storage or retention of data. Debugging is a methodical process of identifying and reducing the number of defects (i.e., “bugs”) in a memory sub-system that cause the aforementioned error or faults. Various debug techniques can be used to detect anomalies, assess their impact, and schedule hardware changes, firmware upgrades, or full updates to the memory sub-system. The goals of debugging include identifying and fixing bugs in the system (e.g., logical or synchronization problems in the firmware, or a design error in the hardware) and collecting system state information, such as information about the operation of the memory sub-system, that may then be used to analyze the memory sub-system to find ways to recover from faults, boost its performance, or to optimize other important characteristics.

In certain systems, debugging operations or other analyses of the memory sub-system are performed on a separate computing device, such as a host computing system, communicably coupled to the memory sub-system through a communication pipe. The communication pipe can be implemented using any one of various technologies, and can include, for example, a peripheral component interconnect express (PCIe) bus, or some other type of communication mechanism. When performing debugging operations, these conventional systems transfer debugging information, such as system state information, statistics, runtime analytics, etc. from the memory sub-system to the host system over the PCIe bus. In order to transfer the debugging information over the PCIe bus, the data must be formatted according to a specific specification, such as the NVM Express (NVMe) specification. In addition, the transfer of the debugging information utilizes bandwidth of the PCIe bus, which then cannot be used for other memory sub-system and host operations. Certain types of faults in the memory sub-system prevent use of the PCIe bus for any communication, much less the transfer of debugging information. In some cases, the memory sub-system may be permanently integrated into some other system, such as by using a ball grid array packaging technique to attach the memory sub-system to a printed circuit board or other substrate containing other electrical components. This form factor is common in some embedded systems, such as automotive implementations, and may include, for example, the entire media control unit of an automobile. When the memory sub-system is permanently integrated with other components, and the PCIe bus is not available for transfer of debugging information, the only option for inspection and debugging may be to physically destroy the packaging in order to gain access to the memory sub-system. Such an approach is expensive, destructive, and should be avoided if possible. Failure to perform debugging, however, can result in inoperability of the memory sub-system, as well as the other components integrated together with the memory sub-system.

Aspects of the present disclosure address the above and other deficiencies by implementing recovery of a non-responsive memory sub-system using backup firmware enabled by a host-initiated hardware recovery signal. Responsive to an unexpected error or other fault, the memory sub-system may become non-responsive, such that the host system can no longer communicate with the memory sub-system. In such an instance, the host system can assert a hardware recovery signal that is transferred to the memory sub-system in a side-band interface, such as a general-purpose input-output (GPIO) pin that is physically separated from the in-band interface (e.g., the PCIe bus). The host system can further initiate a power-cycle of the memory sub-system by temporarily removing the power applied to the memory sub-system and then restoring the power after a period of time. When restarting in response to the power-cycle, the memory sub-system can sample the recovery signal at the GPIO pin. Under normal circumstances when the recovery signal is not asserted by the host system, the memory sub-system can proceed with retrieving a default firmware image from an on-chip datastore, loading that default firmware, and proceeding with normal operations. If however, the memory sub-system determines that the recovery signal is asserted by the host system, the memory sub-system can instead retrieve a backup firmware image from the on-chip datastore and load that backup firmware. In one embodiment, the backup firmware image enables debug functionality that is not normally available with the default firmware. For example, the backup firmware image can allow the memory sub-system to convey status information to the host system, unlock certain bi-directional ports in the memory sub-system to allow for debugging operations to be performed, permit access to certain vendor specific logs in the memory sub-system to which access is normally restricted, allow for the download of firmware updates to fix identified bugs, or enable other debug functionality.

Advantages of the approach described herein includes, but is not limited to, improved debugging in the memory sub-system. By utilizing the host-initiated recovery signal to control what firmware is loaded onto the memory sub-system after a power-cycle, the host system gains some element of control over recovery and debugging after encountering a non-responsive memory sub-system. Such recovery and debugging can be performed with the memory sub-system remaining in place and does not require the destruction of permanent bonds (e.g., BGA) in the package. In addition, this can reduce the need for specialized hardware and software to be added to the memory sub-system, which retains physical space and existing resources for use in other operations of the memory sub-system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface 122. Examples of a physical host interface 122 include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface 122 can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the PCIe interface. The physical host interface 122 can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface 122. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the memory sub-system 110 includes a recovery manager component 113 that coordinates recovery of a non-responsive memory sub-system 110 using backup firmware enabled by a host-initiated hardware recovery signal received over a side-band interface 124, which is separate from the primary physical host interface 122. Responsive to an unexpected error or other fault, the memory sub-system 110 may become non-responsive, such that the host system 120 can no longer communicate with the memory sub-system 120 over the physical host interface 122. In such an instance, the host system 120 can assert a hardware recovery signal that is transferred to the memory sub-system 110 over the side-band interface 124, which can include for example, a general-purpose input-output (GPIO) pin that is physically separated from the PCIe bus used as the primary physical host interface 122. The host system 120 can further initiate a power-cycle of the memory sub-system 110 by temporarily removing the power applied to the memory sub-system 110 and then restoring the power after a period of time. When restarting in response to the power-cycle, the recovery manager 113 of the memory sub-system can sample the recovery signal at the side-band interface 124. Under normal circumstances when the recovery signal is not asserted by the host system 120, the recovery manager 113 can proceed with retrieving a default firmware image from an on-chip datastore (e.g., local memory 119, memory device 130, or memory device 140), loading that default firmware, and proceeding with normal operations. If however, the recovery manager 113 determines that the recovery signal is asserted by the host system 120, the recovery manager 113 can instead retrieve a backup firmware image from the on-chip datastore and load that backup firmware. In one embodiment, the backup firmware image enables debug functionality that is not normally available with the default firmware. For example, the backup firmware image can allow the memory sub-system 110 to convey status information to the host system 120, unlock certain bi-directional ports in the memory sub-system 110 to allow for debugging operations to be performed, permit access to certain vendor specific logs in the memory sub-system 110 to which access is normally restricted, allow for the download of firmware updates to fix identified bugs, or enable other debug functionality. Further details with regard to the operations of the recovery manager 113 are described below.

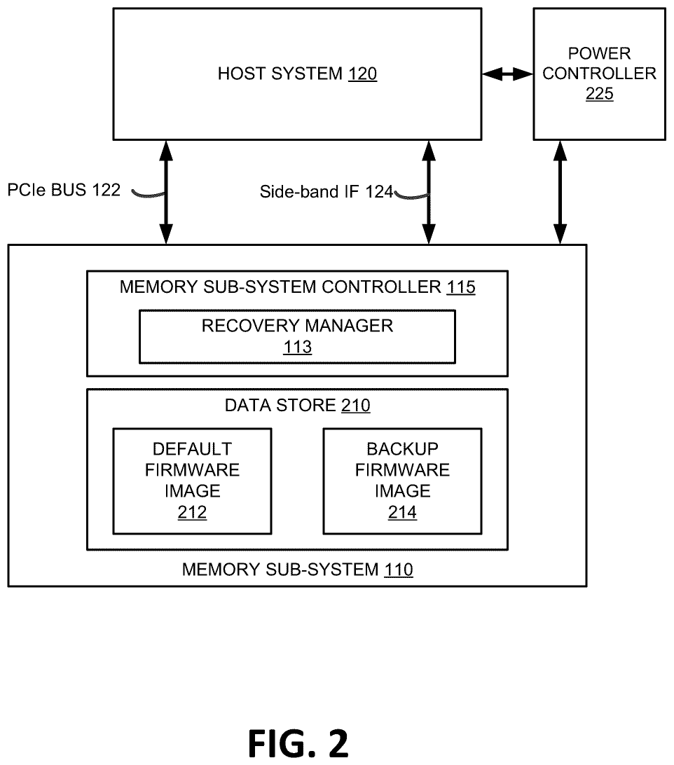

FIG. 2 is a block diagram illustrating a computing system for recovery of a non-responsive memory sub-system using backup firmware enabled by a host-initiated hardware recovery signal in accordance with some embodiments of the present disclosure. In one embodiment, host system 120 is coupled to memory sub-system 110 by physical host interface 122 (e.g., a PCIe bus) and by a side-band interface 124. Host system 120 may include respective bus ports for each interface, as well as corresponding interface drivers. These interface drivers can provide programming interfaces to control and manage the signals sent at the corresponding ports. Host system 120 may further include a host operating system and or one or more customer applications running on top of host operating system that can access the hardware functions of bus ports (e.g., to send and receive data) via the corresponding drivers. For example, the host operating system or customer applications can invoke a routine in either driver, which in turn can issue a corresponding command or commands to the associated port. In one embodiment, host system 120 communicates with power controller 225, which provides power to memory sub-system 110. Upon determining that memory sub-system 110 is not responsive (i.e., is not responding to requests or commands sent via physical host interface 122, processing logic executing on host system 120, can initiate a power-cycle event by sending a command to power controller 225 to temporarily disable power supplied to memory sub-system 110 and then restore power to memory sub-system 110 after a period of time. Before, during, or after this power-cycle event, the host system 120 can assert the recovery signal via side-band interface 124, which can be detected by recovery manager 113 when memory sub-system 110 restarts after the power-cycle event.

In one embodiment, the memory sub-system 110 also includes respective bus ports to which PCIe bus 122 and the side-band interface 124 are coupled. As in host system 120, the bus ports in memory sub-system 110 can be controlled by corresponding device drivers. As described above, memory sub-system controller 115 includes recovery manager 113, which can control sampling of the recovery signal at side-band interface 124, such as by using the corresponding device driver and bus port. In response to determining that the recovery signal is not asserted on the side-band interface 124, recovery manager 113 can retrieve default firmware image 212 from an on-chip datastore 210, loading that default firmware, and proceeding with normal operations. Datastore 210 can include one of local memory 119, memory device 130, or memory device 140, as described above with respect to FIG. 1. In response to determining that the recovery signal has been asserted on the side-band interface 124, however, recovery manager 113 can instead retrieve backup firmware image 214 from the datastore 210 and load that backup firmware. As described herein, the backup firmware image 214 is different from the default firmware image 212 and enables debug functionality that is not normally available with the default firmware.

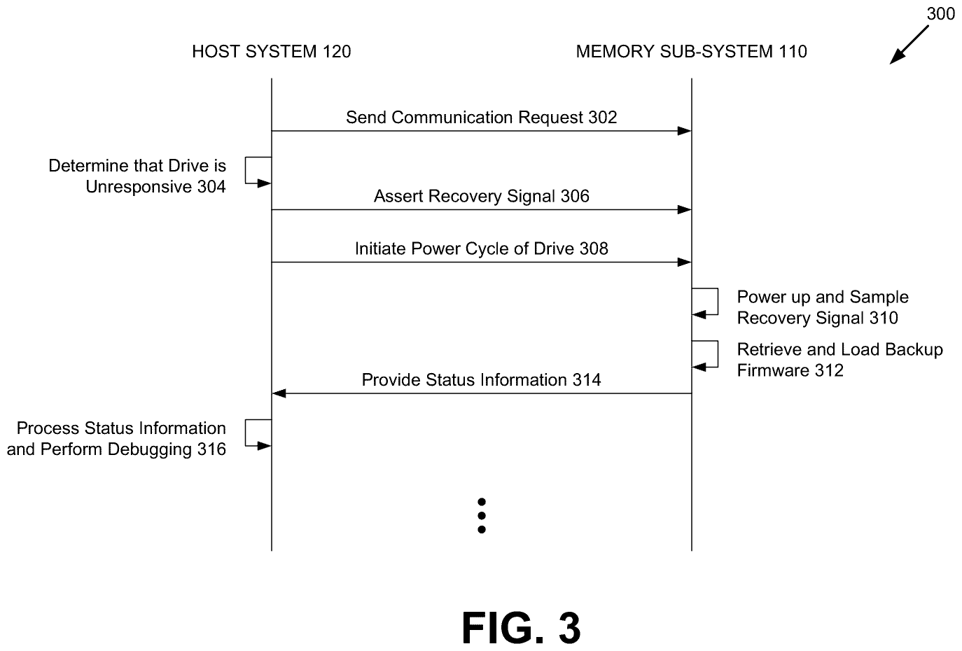

FIG. 3 is a sequence diagram illustrating recovery of a non-responsive memory sub-system using backup firmware enabled by a host-initiated hardware recovery signal in accordance with some embodiments of the present disclosure. The sequence diagram 300 illustrates one embodiment of the data exchange procedure performed between memory sub-system 110 and host system 120. At operation 302, host system 120 sends a communication request to memory sub-system 110. The communication request can be any type of command or request, such as a memory access request (e.g., a read command, a program command), a status request, a vendor specific command, etc. In one embodiment, the communication request is sent to the memory sub-system 110 over PCIe bus 122. Under normal circumstances, the memory sub-system 110 would respond to the communication request (e.g., with the requested data, with a confirmation message, with an error message). In certain circumstances, however, the memory sub-system 110 may not respond, such as if the memory sub-system 110 has suffered some fault or error that impact performance and/or operability. Thus, if after a certain period of time, or after a certain number of requests, the host system 120 has not received a response, at operation 304, the host system 120 can determine that memory sub-system 110 is non-responsive.

Upon determining that the memory sub-system 110 is non-responsive, at operation 306, the host system 120 can assert the recovery signal on side-band interface 124 and, at operation 308, can initiate a power cycle of memory sub-system 110. In one embodiment, the host system 120 asserts the recovery signal by driving a voltage representing a logical “high” state (e.g., a voltage above a threshold) on the side-band interface 124, which can be received at the memory sub-system 110 (e.g., at a GPIO pin to which the side-band interface 124 is connected). In one embodiment, the host system 120, can initiate a power-cycle event by sending a command to power controller 225 to temporarily disable power supplied to memory sub-system 110 and then restore power to memory sub-system 110 after a period of time.

At operation 310, the memory sub-system 110 boots up after power is restored. In addition to numerous diagnostic checks that may be performed, the recovery manager 113 of memory sub-system controller 115 can sample the recovery signal as part of the boot-up process. In response to determining that the recovery signal has been asserted on the side-band interface 124, at operation 312, recovery manager 113 can retrieve backup firmware image 214 from the datastore 210 and load that backup firmware. As described herein, the backup firmware image 214 is different from a default firmware image 212 and enables debug functionality that is not normally available with the default firmware. At operation 314, recovery manager 314 provides status information to host system 120. This status information can include, among other information, an indication that the memory sub-system has rebooted and that the backup firmware has been loaded. The status information can include an indication of the fault or error, if known, that caused memory sub-system 110 to be unresponsive. Receipt of the status information can indicate to host system 120 that the memory sub-system 110 is executing in a debug mode of operation. Accordingly, at operation 316, host system 120 can process the status information and perform one or more debugging operations. The debugging operations can include, for example, requesting additional status information from memory sub-system 110, sending debug commands or requests to various bi-directional ports in the memory sub-system 110 that have been activated, requesting access to certain vendor specific logs in the memory sub-system 110, providing firmware updates to fix identified bugs, or other debug operations.

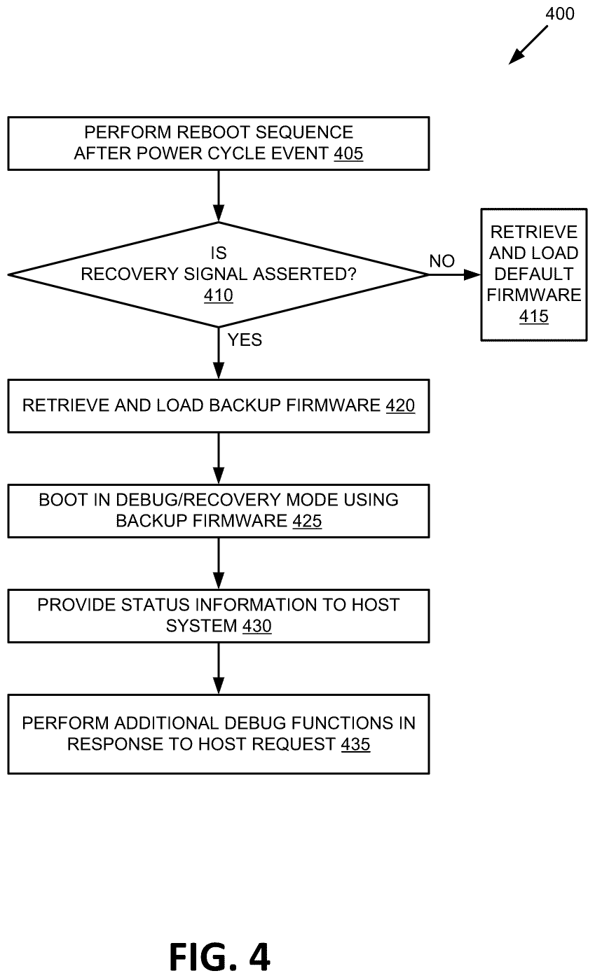

FIG. 4 is a flow diagram of an example method for recovery of a non-responsive memory sub-system using backup firmware enabled by a host-initiated hardware recovery signal in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by recovery manager component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing logic (e.g., recovery manager component 113) performs a reboot sequence in response to an occurrence of a power cycle event. In one embodiment, a host system 120 can initiate the power-cycle event by sending a command to power controller 225 to temporarily disable power supplied to memory sub-system 110 and then restore power to memory sub-system 110 after a period of time. Such a power-cycle event can be initiated in response to the memory sub-system 110 being unresponsive to the host system 120. For example, the power cycle event can include a temporary loss of power to the memory sub-system 110 for a period of time initiated by the host system 120 in response to the memory sub-system 110 being non-responsive.

At operation 410, the processing logic samples a recovery signal received from a host system via a side-band interface 124, and determines whether the recovery signal is asserted. In one embodiment, the host system 120 asserts the recovery signal by driving a voltage representing a logical “high” state (e.g., a voltage above a threshold) on the side-band interface 124, which can be received at the memory sub-system 110 (e.g., at a GPIO pin to which the side-band interface 124 is connected). In one embodiment, the recovery signal is asserted by the side-band interface 124 separate from a primary interface, such as PCIe bus 122, between the memory sub-system 110 and the host system 120.

Responsive to determining that the recovery signal is not asserted, at operation 415, the processing logic retrieves and loads a default firmware image for the memory sub-system and boots the memory sub-system in a default operational mode using the default firmware image. one embodiment, recovery manager 113 retrieves default firmware image 212 from the datastore 210 and loads that default firmware. The default firmware enables the default operational mode that can be used when a major system fault or error is not detected. In the default operational mode, certain debugging capabilities may not be available. For example, certain ports may not be accessible by host system 120, certain event logs may be restricted, etc.

Responsive to determining that the recovery signal is asserted, at operation 420, the processing logic retrieves and loads a backup firmware image for the memory sub-system. In one embodiment, recovery manager 113 retrieves backup firmware image 214 from the datastore 210 and loads that backup firmware. In one embodiment, the backup firmware is preinstalled on memory sub-system 110 such that it can be available in case of a major system fault or error that requires additional debugging capabilities.

At operation 425, the processing logic boots the memory sub-system in a debug operational mode using the backup firmware image. As described herein, the debug operational mode can be different from the default operational mode such that certain debug functionality that is not normally available in the default operational mode is available. That is, the debug operational mode permits one or more debug functions that are not permitted in the default operational mode.

At operation 430, the processing logic provides status information to host system 120. This status information can include, among other information, an indication that memory sub-system has rebooted and that the backup firmware has been loaded. The status information can include an indication of the fault or error, if known, that caused memory sub-system 110 to be unresponsive. Receipt of the status information can indicate to host system 120 that the memory sub-system 110 is executing in the debug operational mode.

At operation 435, the processing logic performs one or more debug functions in response to a host request. In one embodiment, the one or more debug functions include unlocking one or more bi-directional communication ports in the memory sub-system 110 to allow for a debug operation to be performed. In one embodiment, the one or more debug functions include granting access to one or more vendor specific logs in the memory sub-system 110. In one embodiment, the one or more debug functions including downloading updated firmware to address a fault in the memory sub-system 110.

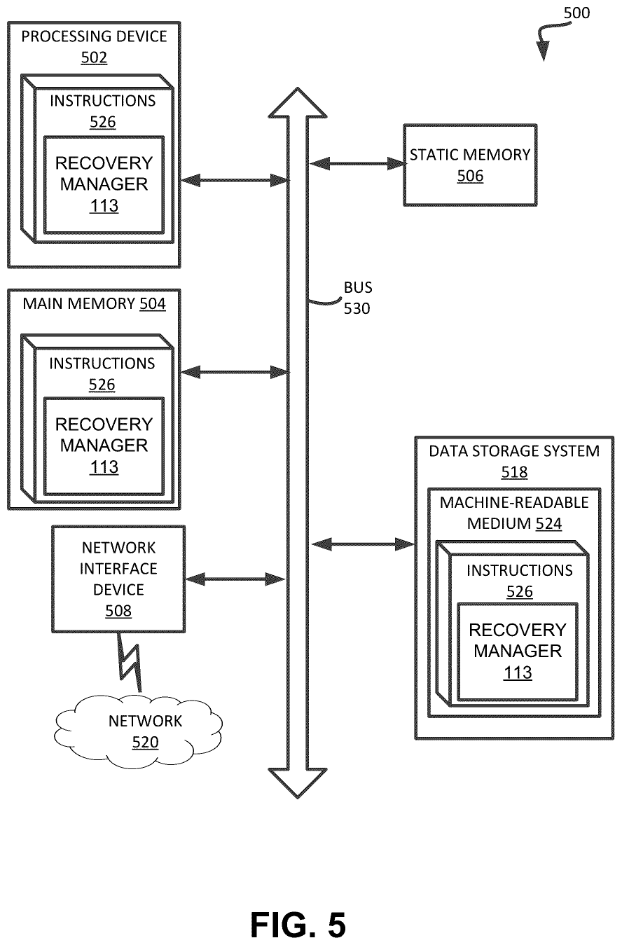

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the recovery manager component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the recovery manager component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device;
a processing device, operatively coupled with the memory device, to perform operations comprising:
performing a reboot sequence in response to an occurrence of a power cycle event;
determining whether a recovery signal is asserted from a host system via a side-band interface;
responsive to determining that the recovery signal is asserted, retrieving and loading a backup firmware image for the memory sub-system; and
booting the memory sub-system in a debug operational mode using the backup firmware image.

2. The memory sub-system of claim 1, wherein the power cycle event comprises a temporary loss of power for a period of time initiated by the host system in response to the memory sub-system being non-responsive.

3. The memory sub-system of claim 1, wherein the recovery signal is asserted via the side-band interface separate from a primary interface between the memory sub-system and the host system.

4. The memory sub-system of claim 1, wherein the processing device is to perform operations further comprising:
responsive to determining that the recovery signal is not asserted, retrieving and loading a default firmware image for the memory sub-system; and
booting the memory sub-system in a default operational mode using the default firmware image.

5. The memory sub-system of claim 4, wherein the debug operational mode permits one or more debug functions that are not permitted in the default operational mode.

6. The memory sub-system of claim 5, wherein the one or more debug functions comprise unlocking one or more bi-directional communication ports in the memory sub-system to allow for a debug operation to be performed.

7. The memory sub-system of claim 5, wherein the one or more debug functions comprise granting access to one or more vendor specific logs in the memory sub-system.

8. The memory sub-system of claim 5, wherein the one or more debug functions comprise downloading updated firmware to address a fault in the memory sub-system.

9. A method comprising:
performing a reboot sequence of a memory sub-system in response to an occurrence of a power cycle event;
determining whether a recovery signal is asserted from a host system via a side-band interface;
responsive to determining that the recovery signal is asserted, retrieving and loading a backup firmware image for the memory sub-system; and
booting the memory sub-system in a debug operational mode using the backup firmware image.

10. The method of claim 9, wherein the power cycle event comprises a temporary loss of power for a period of time initiated by the host system in response to the memory sub-system being non-responsive.

11. The method of claim 9, wherein the recovery signal is asserted via the side-band interface separate from a primary interface between the memory sub-system and the host system.

12. The method of claim 9, further comprising:
responsive to determining that the recovery signal is not asserted, retrieving and loading a default firmware image for the memory sub-system; and
booting the memory sub-system in a default operational mode using the default firmware image.

13. The method of claim 12, wherein the debug operational mode permits one or more debug functions that are not permitted in the default operational mode.

14. The method of claim 13, wherein the one or more debug functions comprise unlocking one or more bi-directional communication ports in the memory sub-system to allow for a debug operation to be performed.

15. The method of claim 13, wherein the one or more debug functions comprise granting access to one or more vendor specific logs in the memory sub-system.

16. The method of claim 13, wherein the one or more debug functions comprise downloading updated firmware to address a fault in the memory sub-system.

17. A non-transitory computer-readable storage medium comprising instructions that, when executed by a processing device, cause the processing device to perform operations comprising:
performing a reboot sequence of a memory sub-system in response to an occurrence of a power cycle event;
determining whether a recovery signal is asserted from a host system via a side-band interface;
responsive to determining that the recovery signal is asserted, retrieving and loading a backup firmware image for the memory sub-system; and
booting the memory sub-system in a debug operational mode using the backup firmware image.

18. The non-transitory computer-readable storage medium of claim 17, wherein the power cycle event comprises a temporary loss of power for a period of time initiated by the host system in response to the memory sub-system being non-responsive.

19. The non-transitory computer-readable storage medium of claim 17, wherein the recovery signal is asserted via the side-band interface separate from a primary interface between the memory sub-system and the host system.

20. The non-transitory computer-readable storage medium of claim 17, wherein the instructions cause the processing device is to perform operations further comprising:
responsive to determining that the recovery signal is not asserted, retrieving and loading a default firmware image for the memory sub-system; and
booting the memory sub-system in a default operational mode using the default firmware image, wherein the debug operational mode permits one or more debug functions that are not permitted in the default operational mode.
